(19) United States
(12) Patent Application Publication
(10) Pub. No.: US 2009/0319579 A1
(43) Pub. Date: Dec. 24, 2009

(54) Electronic Design Automation Process Restart

(76) Inventor: Fedor Pikus, Beaverton, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/121,744

(22) Filed: May 15, 2008

Related U.S. Application Data
(60) Provisional application No. 60/938,149, filed on May 15, 2007.
(60) Provisional application No. 60/990,695, filed on Nov. 28, 2007.

(51) Int. Cl. G06F 17/30; G06F 17/50

(52) U.S. Cl. 707/203; 716/11; 716/5; 706/47; 707/E17.005

(57) ABSTRACT

Various implementations of the invention provide the ability to extract and compare attributes for individual layout objects, and/or provide support for user-defined properties, and/or provide for fast data retrieval, and/or provide connectivity-awareness, and/or provide an optimized framework for large hierarchical designs, and/or provide a seamless interface with a standard set of layout processing operations, and/or provide the ability to run a layout processing rule incrementally, and/or provide the ability to more fully analyze results of the layout processing. In further examples of the invention, the ability to save and analyze design properties to any layout design processing work flow is provided.

### RELATED APPLICATIONS

This application claims priority to U.S. Provisional Patent Application No. 60/938,149 entitled “Hierarchical Database Analysis Process Restart,” filed on May 15, 2007, and naming Fedor G. Pikus as inventor, and to U.S. Provisional Patent Application No. 60/990,695 entitled “Electronic Design Automation Process Restart,” filed on Nov. 28, 2007, and naming Fedor G. Pikus at inventor, which applications are incorporated entirely herein by reference.

### FIELD OF THE INVENTION

The invention relates to the field of electronic design automation. More specifically, various embodiments of the invention relate to starting and restarting an electronic design automation process.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the components and their interconnections are established, the design is again transformed. This time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks. Once the microcircuit device design is finalized, the layout portion of the design can be used by fabrication tools to manufacturer the device using a photolithographic process.

As designers and manufacturers continue to increase the number of circuit components in a given area and/or shrink the size of circuit components, the shapes reproduced on the substrate (and thus the shapes in the mask) become smaller and closer together. This reduction in feature size increases the difficulty of manufacturing the device based upon the layout design. The difficulties often result in various defects, for example the intended image is not accurately “printed” onto the substrate, or the interconnecting lines are too close together and “interfere” with each other. These various defects typically cause flaws in the manufactured device. Accordingly, there is a need to process layout data both to ensure that the intended layout can be accurately reproduced and that the layout will not cause any unwanted behaviors to manifest themselves in the design.

While processing layout data is essential to any design flow, it is also very expensive in terms of both computing resources and processing time. Layout designs can be very large. For example, even one layout data file for a single layer of a field programmable gate array may be approximately 58 gigabytes. Accordingly, performing any processing on a design is computationally intensive. Repeating the processing, as is often required, only adds to the time required to finalize the layout design. The time required for processing layout data only increases as the feature size of designs decrease and as the number of features in a given design increases. For example, processing the layout for a 45 nm device requires greater computing resources than required to process the layout for a 65 nm level device. Although many sophisticated tools exist for processing layout design data, for example Mentor Graphics' Calibre, the resource requirement is still significant. Due to the fact that processing layout data is computationally intensive, entire workstations or even entire workstation clusters are unavailable for other uses while the layout processing tools are running.

### SUMMARY OF THE INVENTION

Aspects of the invention relate to techniques for managing the layout design data required when designing for improved manufacturability and yield.

Various implementations of the invention provide the ability to extract and compare attributes for individual layout objects, and/or provide support for user-defined properties, and/or provide for fast data retrieval, and/or provide connectivity-awareness, and/or provide an optimized framework for large hierarchical designs, and/or provide a seamless interface with a standard set of layout processing operations, and/or provide the ability to run a layout processing rule incrementally, and/or provide the ability to more fully analyze results of the layout processing. In further examples of the invention, the ability to save and analyze design properties to any layout design processing work flow is provided.

These and other features and aspects of the invention will be apparent upon consideration of the following detailed description.

### BRIEF DESCRIPTION OF THE DRAWINGS

The present invention will be described by way of illustrative embodiments shown in the accompanying drawings in which like references denote similar elements, and in which:

FIG. 1 is an illustration of a layout data management system implemented according to various embodiments of the present invention;

FIG. 2 is an illustration of a layout design flow, utilizing the layout data management system of FIG. 1;

FIG. 3 is an illustration of a method for processing layout data utilizing various embodiments of the present invention;

FIG. 4 is an illustration of a state diagram for a layout database file.

### DETAILED DESCRIPTION OF ILLUSTRATIVE EMBODIMENTS

### A Layout Data Management System

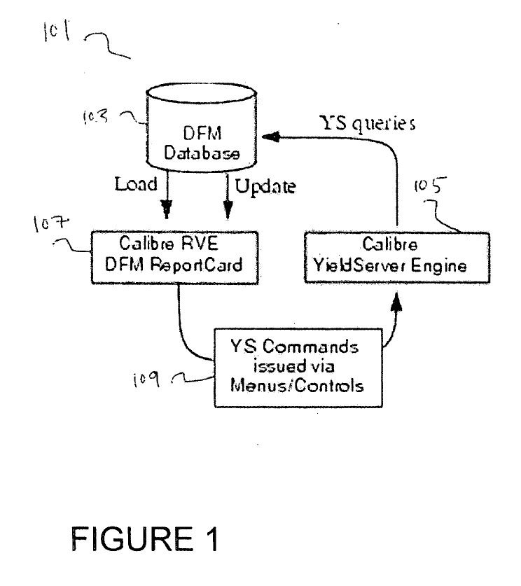

FIG. 1 illustrates an example of a layout data management system 101 that may be implemented according to various embodiments of the invention. As seen in FIG. 1, the layout data management system 101 includes a database 103, a database processing module 105, a control module 107, and an interface module 109. The database 103 is a layout database. In various implementations of the invention, the database 103 is in the DFM database format, a proprietary database format designed by Mentor Graphics. The database 103 is capable of storing hierarchical layout objects along with their associated attributes and properties. Various tools exist for creating a database suitable for use as the database 103 in layout data management system 101. For example, Mentor Graphics' Calibre dfm executive, an electronic design automation tool available from Mentor Graphics Corporation of Wilsonville Oreg. The database processing module 105 provides a means to query, manipulate, modify, and/or create data in the database 103. The control module 107 provides a command and control set for interfacing with the database processing module 105. The interface module 109 provides a structure or language for interfacing with the database processing module 105. In various implementations of the invention, the interface module 109 is based on a Tcl command language.

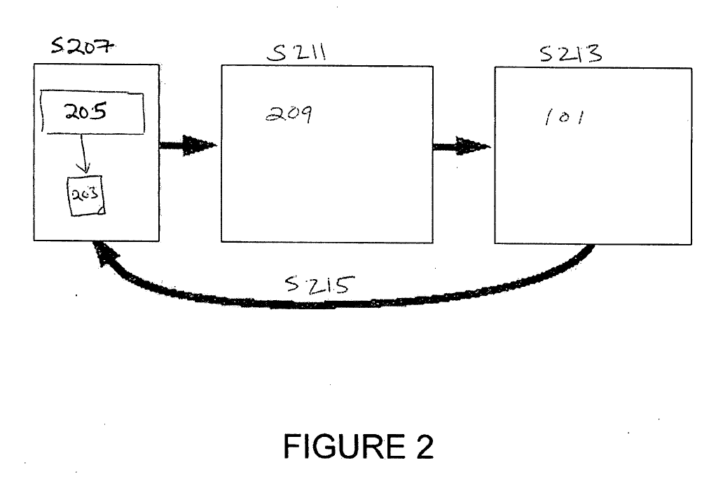

A layout data management system 101, implemented according to various embodiments of the invention, adds the ability to save and analyze design properties to any design rule check (DRC) or design for manufacturability (DFM) work flow. FIG. 2 illustrates a typical layout design workflow utilizing a layout data management system 101 as part of the workflow. As can be seen in FIG. 2, a layout 203 is designed with a layout design tool 205 at S207. Next, a layout verification tool 209, such as Mentor Graphics' Calibre, is sued to verify the design at S211. Next, the verification is analyzed using the layout data management system 101 at S213. If correction to the layout is needed, Step 215 indicates that Steps 207, 211 and 213 may be repeated. Although the workflow is relatively unchanged for designers and engineers, more visibility and control over the process is obtained.

### Using A Layout Data Management System

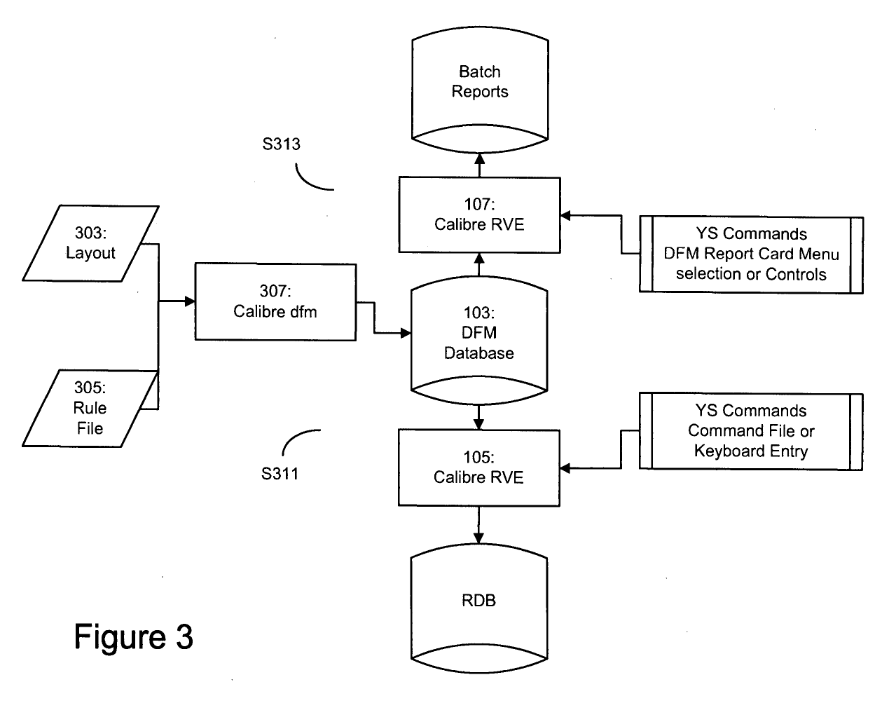

FIG. 3 illustrates a method for processing layout data utilizing various embodiments of the invention. As can be seen in FIG. 3, a layout data file 303 and a rule deck 305 are provided to a layout verification or layout processing tool 307 at S309. The layout processing tool 307 incorporates the rule deck 305 into the layout data file 303 and creates a database 103. The rule deck 305 is a file that either defines or provides means to extract or calculate properties of the layout data file 303. Next, the database 103 may be loaded and processed by the database processing module 105 at S311. Alternatively, the database 103 may be loaded and processed by the control module 107 at S313

In various implementations of the invention, the database processing module 105 may be invoked from a command prompt. For example, a UNIX or Linux command prompt. Invoking the database processing module 105 this way lets the user issue commands interactively at the command line prompt or as a batch using a script, such as a Tcl script or command file. An example database processing module 105 is the Calibre YieldServer by Mentor Graphics. The Calibre YieldServer may be invoked from the command line by the following syntax:

calibre -ys[-dfmdb dfmdb][shell_redirection_input|-exec script_file[arg. . . ]]

In various embodiments of the invention, the database processing module 105 can execute commands supplied through a UNIX shell input redirection, using either “<” or “<<”. A difference between execution via a script or source command and via redirection is that if an error is encountered while executing using a script or source command, the processing run will terminate, while if an error is encountered while executing using input redirection, the processing run will not terminate.

Still, in various implementations of the invention, when executing without input redirection, the database processing module 105 responds by displaying a software header followed by a Tcl prompt. At the Tcl prompt, the user can do either of two things. First the user may use the Tcl source command to execute an existing database processing module 105 Tcl script. Alternatively, the user may enter commands one by one at the Tcl prompt. This method provides the maximum flexibility because it allows the user to decide how to proceed based on the data currently being worked with. In various embodiment of the invention, the data processing module 105 provides a method for the user to capture the commands being issued for future use.

Additionally, various implementations of the invention provide the user with the ability to invoke the database processing module 105 through the control module 107. In various implementation of the invention, the control module 107 provides a graphical user interface, which facilitates control and interaction with the database processing module 105 in a convenient manner using a tabular interface. Additionally, greater visibility into the database 103 is provided to the user in a graphical format. Still, in various implementations of the invention, the control module 107 interfaces with the database processing module 105 via the interface module 109.

In various implementations of the invention, the control module uses the database 103 along with the layout database file 303 to provide the user with results from analysis performed on the layout data, for example, verification results.

Still, in various implementations of the invention, the database processing module 105 may be invoked automatically once a layout verification tool 307 has processed the layout file, and created the database 103. Invoking the database processing module 105 in this way lets the user begin with a layout database in any of the supported formats, such as OASIS or GDSII, have it converted into a database 103, then evaluate the database 103 in a single run.

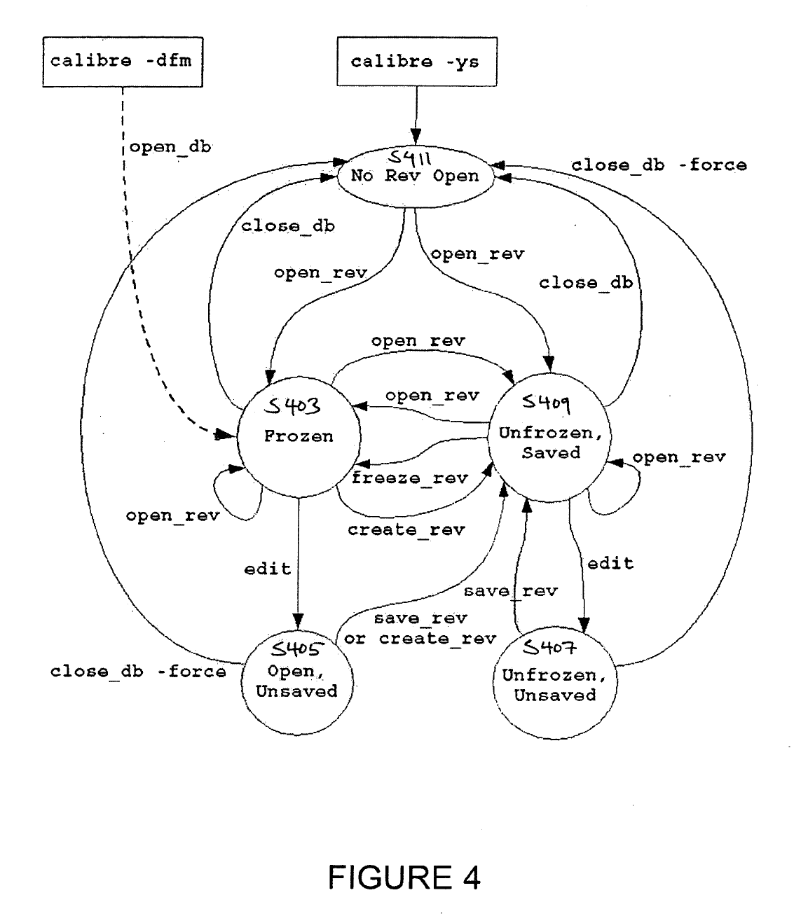

FIG. 4 illustrates a state diagram 401 showing a means by which the database 103 may be modified by a database processing unit 105. For example, in various implementations, the database 103 may be modified using a first rule deck 305, saved, and subsequently modified using a second rule deck 305 without having to re-compute the earlier computed rules. This feature is facilitated by the ability to maintain different versions of the database 103, as will be apparent from the rest of the disclosure. As can be seen in FIG. 4, there are five (5) possible states. More particularly, there are five (5) possible states which the database processing module 105 may place the database 103 in. The database 103 may be either frozen in state 403, open and unsaved in state 405, unfrozen and unsaved in state 407, unfrozen and saved in state 409, or closed as in state 411. More particularly, when in state 403, the version of the database 103 is a finalized version. Once a database is frozen, it can no longer be modified but can be used as a parent for new versions. When the database 103 is in state 405 it is a version with unsaved changes. For example, the version could be a newly created database from a database in state 403. When the database 103 is in state 407, it is a database that has unsaved changes and has not been frozen or finalized. Additionally, when the database 103 is in state 409, it is a database that has no unsaved changes, but has still not been frozen or finalized. When the database version of the database 103 is in state 411, there are no open database versions.

As can be seen from FIG. 4, there are multiple transition paths between states. For example, a database 103 in state 403 may be closed by the database processing module 105, to place the database in state 411. In various embodiments of the invention, the database processing module 105 supports the following commands to process and transition the database versions between states. A database version in either state 403 or 409 may be closed via the close_db command. Additionally, a database version in either state 405 or 407 may be forced to close with command close_db by using the “-force” argument. A database version in either state 405 or 407 may be saved as the current version via the save_rev command. Still, a database version in either state 403 or 405 may be copied to create a new version via the create_rev command. Still further, a database version in state 409 may be finalized via the freeze_rev command.

Additionally, in various embodiment or implementations of the invention, the the following commands will be available, and may be useful for modifying a version of the database 103 by using the database processing module 105. The get_current_rev command returns the revision name for the current open revision. The list_revs command returns a list of revisions for the currently open database. The open_db command opens a database of the same format as the database 103. The open_rev command opens a specified revision of the current database, if it exists. The set_default_rev command defines the revision of the database to be opened by default. Use of these commands and their effect on the state of the database 103 is illustrated in FIG. 4.

### Process Restart Utilizing The Database Processing Module

As stated previously, one benefit to using the database processing module 105 is that the user is provided with the ability to stop and resume the validation or analysis of a layout data file 303 without being required to recalculate any already processed rules. A significant benefit to this is the ability to update the rule deck 305 during validation.

An example tool which is implemented according to various examples or embodiments of the invention is the Calibre YieldServer tool, available from Mentor Graphics Corporation of Wilsonville Oreg. As an example of various implementations of the invention and the ability to resume modification of a layer of layout data the command new_layer, available via the YieldServer tool is discussed below. The new_layer command creates new layers in the database 103, for example a runtime DFM database, by executing a series of layer operations available through the layout processing tool 307. For example, the following command would create a new layer available for manipulation.

dfm::new_layer{-svrf svrf_cmds|-tvf tvf_text}[-keep_all_layers|-dfm|-drc]

The new_layer command executes Calibre rules in SVRF or TVF format. All layers that exist in the active DFM database are made available as input layers to the operations in the svrf_cmds or tvf_text. As layers are created by the operations, they are added to the nmDRC Hierarchical Database in memory. Depending on the options to new_layer and on the way the layers are used in the rules, new layers created by the operations are either deleted from the nmDRC hierarchical database in memory before new_layer completes, or are “kept” added to the DFM database in memory.

In various embodiments, the new_layer command does not return anything to the user. The following arguments are available to the user to direct the result of the new_layer command.

The “-svrf svrf_cmds” argument is a required keyword and argument pair that defines the operations to use in generating the data for the new layer. You must specify either -svrf or -tvf. The string must be surrounded by the appropriate Tcl delimiters, such as braces { } or quotes “”. The argument {svrf_cmds} is a series of standard verification rule format (SVRF) operations. Within these operations you can access variables defined in either previous new_layer runs in the same session or in the original batch run using VARIABLE statements from the original batch run. You can issue new VARIABLE statements to create new variables but you cannot reset existing variables. Although the {svrf_cmds} argument is a series of SVRF operations, the argument cannot contain the following operations: LAYER, CONNECT, DEVICE; POLYGON, or LAYOUT POLYGON.

The “-tvf tvf_text” argument is a required keyword and argument pair defining the operations to use in generating the data for the new layer. You must specify either -svrf or -tvf, and like the previous argument, the string must be surrounded by the appropriate Tcl delimiters, such as braces { } or quotes “”. The argument {tvf_text} cannot contain either the “#!tvf” statement or any of the following operations: LAYER, CONNECT, DEVICE, POLYGON, LAYOUT POLYGON.

The “-keep_all_layers|-dfm|-drc” argument is an optional argument used to control the type of processing performed for the rules that are passed to the command using the -svrf or -tvf keyword. Using the argument without a modifier specifies that a processing behavior unique to the dfm::new_layer command be used. The behavior has the following properties: all operations in the rule deck are executed regardless of the presence of checks or SELECT CHECK statements that may exist. Additionally, the DFM RDB operations are no-ops because all layers are kept anyway, unless the -rdbs_as_files option is present. Still, all layers created are kept after the run, except for implicit TMP<n> layers and any encrypted layers. Still, further the RDB outputs from DFM ANALYZE and DFM MEASURE operations are created as layers and kept after the run, unless the -rdbs_as_files option is present. By default, all layers are configured with node numbers if connectivity can be passed to the layer.

The “-dfm” modifier causes the command to behave like the command “calibre -dfm” available to the Calibre toolset by Mentor Graphics Corporation. With this modifier, checks are executed as they are with calibre -dfm. For example, DFM SELECT CHECK and DFM UNSELECT CHECK statements are respected. Additionally, RDB outputs from DFM ANALYZE and DFM MEASURE operations are converted to new layers, unless the -rdbs_as_files option is present. Furthermore, the DFM RDB operations cause their input layers to be kept after the run unless the -rdbs_as_files option is present. Still, the layers created by output operations in checks are kept after the run. Still further, any unassigned COPY operations in checks cause their input layers to be kept after the run. Additionally, the input layers to DFM ANALYZE, DFM MEASURE, and DFM PROPERTY operations are not kept unless -keep_input options are present, and layers are configured with node numbers as required by their use as inputs to nodal operations, or as specified by DFM SELECT CHECK NODAL statements.

The “-drc” modifier causes the command to behave like the command “calibre -drc” available to the Calibre toolset by Mentor Graphics Corporation. With this modifier, checks are executed as with calibre -drc. If there are no SELECT CHECK or UNSELECT CHECK statements, all checks are executed. If there are DRC, ERC, or DFM SELECT CHECK/UNSELECT CHECK statements, they are treated as with calibre -drc. Additionally, the RDB outputs from DFM ANALYZE, DFM MEASURE, and DFM RDB operations are saved to files unless the -rdbs_as_layers option is present. The input layers to DFM ANALYZE, DFM MEASURE, and DFM PROPERTY operations are not kept unless -keep_input options are present. The layers are configured with node numbers as required by their use as inputs to nodal operations. Furthermore, some behavior of -drc depends on the presence or absence of a DRC RESULTS DATABASE statement in the rule file. More precisely, if there is no DRC RESULTS DATABASE statement or -rdbs_as_layers is specified, saving of check results is similar to -dfm, layers created by output operations in checks are kept after the run, and DRC CHECK MAP statements are ignored and unassigned COPY operations in checks cause their input layers to be kept after the run. If there is a DRC RESULTS DATABASE statement and -rdbs_as_layers is not present, the DRC RESULTS DATABASE statement is respected, as are DRC CHECK MAP statements, the layers from output operations are not kept after the run, since they are saved in RDBs, and any unassigned COPY operations send their output to the specified result database.

The “-comments comments_string” argument is an optional argument used to supply a comment string to be written to the database as a property of the new layer. The argument must be a Tcl string and should be enclosed in quotes. Be aware that the delimiters you use to enclose the comments_string can have an impact on how the string can be used in a future analysis run.

The “-keep_analyze_inputs” argument is also an optional argument used to instruct the command to specify that the input layers to the DFM ANALYZE operations are not deleted from the DFM database in memory.

Additionally, the “-keep_measure_inputs” argument is an optional argument used to instruct the command to specify that the input layers to the DFM MEASURE operations are included in the DFM database in memory.

The “-keep_property_inputs” argument is an optional argument used to instruct the command to specify that the input layers to the DFM PROPERTY operations are included in the DFM database in memory.

The “-keep_all_inputs” argument is an optional argument used to instruct the command to specify that the input layers to all DFM operations are included in the DFM database in memory.

The “-rdbs_as_files” argument specifies that RDB options to DFM ANALYZE, DFM MEASURE, and DFM RDB operations, should write RDBs, rather than creating layers. While the “-rdbs_as_layers” argument specifies that RDB options to DFM ANALYZE, and DFM MEASURE, should create layers in the DFM database rather than writing them to DFM RDB files. For the default layer-generation mode, and -dfm, -rdbs_as_layers has no effect except to suppress warning messages about RDBs being saved as layers. These two arguments are used together like ““-rdbs_as_files|-rdbs_as_layers”.

The “-make_nodal” argument is an optional argument used to instruct the command to configure data with node numbers whenever possible. That is, when connectivity can be passed to that layer.

The “-overwritable” argument is an optional argument used to instruct the command to create new layers as overwritable by future dfm::new_layer commands. By default, new layers cannot be overwritten and any attempts to create a layer with a name that already exists results in an error.

Executes Calibre rules in SVRF or TVF format. All layers that exist in the active DFM database are made available as input layers to the operations in the svrf_cmds or tvf_text. As layers are created by the operations, they are added to the nmDRC Hierarchical Database in memory. Depending on the options to new_layer and on they way the layers are used in the rules, new layers created by the operations are either deleted from the nmDRC hierarchical database in memory before new_layer completes, or are “kept”—added to the DFM database in memory.

The following is an example of command line code used by various implementations of the invention to resume manipulation of layout data on an already existing layout database file, such as the database file 103.
dfm::new_layer -svrf{X=DFM PROPERTY A B C[RATIO=AREA(B)/AREA(C)]}

Assuming that A, B, and C are existing layers, this example executes the DFM PROPERTY operation and creates the new layer X, which is kept in memory after the command executes.

Still, the following is an example of command line code used by various implementations of the invention to resume manipulation of layout data on an already existing layout database file, such as the database file 103.

dfm::new layer -dfm -keep_analyze_inputs -make_nodal -svrf {analyze
{

MET1 = COPY M1
DFM ANALYZE MET1
[1−(COUNT(MET1)/(COUNT(MET1)+COUNT(MET1)))] >= 0
WINDOW

100 STEP 50 RDB ONLY result.rdb

}
DFM SELECT CHECK analyze
}\
-comments {YieldServer generated analyze layer}

Assuming that M1 is an existing layer, this example executes the analyze check while keeping the RDB layer from the DFM ANALYZE operation in memory, rather than writing the RDB layer. Additionally, the command keeps layer MET1 in memory because the -keep_analyze_inputs option is present. Furthermore, if M1 is nodal, MET1 will also be nodal because the -make_nodal option is present. Finally, “\” attaches the comment “YieldServer generated analyze layer” to the ANALYZE RDB layer and MET1.

Still further, the following is an example of command line code used by various implementations of the invention to resume manipulation of layout data on an already existing layout data database file, such as the database 103.

dfm::new_layer -keep_property_inputs -drc -svrf {

check.prop{

INT_POLY = INT [POLY] < 4.2
x = DFM PROPERTY INT_POLY [length =

LENGTH(INT_POLY)]

DFM RDB x NULL

```
  }
  DRC SELECT CHECK check.prop
  DRC RESULTS DATABASE ys_db
```

}
dfm::new_layer -svrf (y = DFMPROPERTY “check.prop::INT_POLY”

[length2 = LENGTH( “check.prop::INT_POLY” )]}

Those of skill in the art will appreciate that although mention of specific means to manipulate and process the database was not discussed in detail that various configurations are possible to implement the present invention. For example a standard UNIX workstation with associated hard drive and input and output devices.

### Conclusion

Means and methods are disclosed to facilitate manipulation of layout data files and layout database files, such that processing may be stopped and restarted without providing the need to recomputed previously computed results.

Additionally, although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

What is claimed is:

1. A method of manipulating a database corresponding to a portion of device layout data, comprising:
processing the database based in part on a first rule deck;
storing a version of the database;
processing the version of the database based in part on a second rule deck.

2. The method recited in claim 1, wherein processing the database includes performing layout verification on the portion of layout data.

3. The method recited in claim 1, wherein processing the database includes modifying the portion of layout data.

4. The method recited in claim 1, wherein storing a version of the database includes:
saving the database to a hard disk drive; and
releasing the database from memory.

5. An apparatus for manipulating a database corresponding to a portion of device layout data, comprising:
database processing means, whereby the database may be accessed, modified or manipulated;
a database processing means control module, whereby the database processing means may be interfaced; and
a processing means interface module, whereby the database processing means and the database processing means control module communicate.

6. The apparatus recited in claim 5, wherein the database processing means control module provides a graphical user interface.
